(19) United States
(12) Patent Application Publication
(10) Pub. No.: US 2002/0046100 A1
(43) Pub. Date: Apr. 18, 2002

(54) Image display method

(76) Inventor: Naoto Kinjo, Kanagawa (JP)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/836,540

(22) Filed: Apr. 18, 2001

(30) Foreign Application Priority Data
Apr. 18, 2000 (JP) 2000-116376
May 9, 2000 (JP) 2000-135556

(51) Int. Cl. G06F 17/60; G06K 9/00

(52) U.S. Cl. 705/14; 382/115

(57) ABSTRACT

The image display method extracts a person in a photographed image, detects a first characteristic of the extracted person and switches an image displayed on an image display medium in accordance with the detected first characteristic of the extracted person. It is preferable that the method estimates a second characteristic of the extracted person, for example, a characteristic of this person as a customer from the first characteristic, and switches an image displayed on the image display medium in accordance with the estimated second characteristic as the customer. The method may also switch the displayed content based on the voice of the person, the identified person and the position of the person relative to the image display apparatus.

### BACKGROUND OF THE INVENTION

The present invention relates to an image display method of an advertisement and the like of indoor or outdoors, particularly to an image display method in which an image is displayed by switching display contents in accordance with a viewer, and to an image display method of displaying the image easy to see relative to a position of the viewer.

Heretofore, in order to enhance an advertisement effect, an advertisement display method has been proposed in which advertisement contents are switched in accordance with the viewer so as to display an advertisement suitable for the viewer of the advertisement.

For example, in Japanese Patent Laid-Open No. Hei 9 (1997)-62887 gazette, disclosed is a display method in which information concerning articles and the like is timely displayed so as to fit with characteristics of persons, particularly, characteristics as customers, namely, characteristics of customers (for example, customer class) in a store such as a shopping center.

This method is the one where a store clerk gives a shopping basket attached with a transmitter, in which data regarding a characteristic of the customer (such as age, gender and occupation) is input, to a customer when he/she enters the store, and one of sensors provided at various locations in the store detects a signal from the transmitter as the customer moves in the store carrying the shopping basket with the transmitter. Then, the advertisement suitable for the characteristic of the customer is displayed on a display apparatus near the customer.

However, the foregoing conventional advertisement display method has had a problem that the store clerk has to attach the transmitter to the shopping basket and input data concerning the characteristic of the customer in the transmitter, which is very laborious. There is also a problem of material and human resource such as maintenance and control of the transmitters and disposing a store clerk at a store entrance for data input.

In addition, there has conventionally been an advertisement display method in which a large advertisement poster is posted on a wall or the like in a place where a number of people gather such as a shopping center, a train station, an amusement park and a theater, in order to,allow the advertisement poster to exert a high advertisement function by letting many people see the poster. However, in a paper medium like a poster, the advertisement display contents are fixed, and the only way to change the advertisement display contents is to post another poster, whose operation is laborious. On the contrary, an advertisement by animation with using a large image display apparatus has been performed in recent years. As such an image display apparatus, a liquid crystal display, a fluorescent display tube, a plasma display and the like have been used in place of a conventional Braun tube (CRT) because they can be realized to be a thin type structure. Moreover, a very thin device such as an electronic paper has been developed, and an advertisement display covering a considerably wide area like an entire surface of a wall is about to be realized.

However, since all of the foregoing advertisement display methods are made on the assumption that a display screen is seen straight from the front, there has been a problem that the screen is hard to see when seen from an oblique direction or from far away.

### SUMMARY OF THE INVENTION

The present invention has been created in consideration of the foregoing conventional problems, and a first subject thereof is to provide an image display method capable of enhancing effects of an advertisement by automatically switching an advertisement display of indoors or outdoors so as to fit with a characteristic of the person, particularly, customer whereupon an effect or value of the displayed image can be enhanced for the person or customer.

The present invention has been created in consideration of the foregoing conventional problems, and a second subject thereof is to provide an image display method capable of automatically displaying an image so that the image is easy to see for a person irrespective of the position of the person who sees an image display apparatus.

In order to attain the first object described above, the first aspect of the present invention provides an image display method, comprising the steps of: extracting a person in a photographed image; detecting a first characteristic of the extracted person; and switching an image displayed on an image display medium in accordance with the first characteristic of the extracted person.

Preferably, the first characteristic is at least one of a height, a size of a face, a shape of hairs, a shape of clothes, density distribution of clothes, color distribution of clothes, presence or absence of makeup, and presence or absence of accessories.

It is preferable that the image display method further comprises the steps of: estimating a second characteristic of the extracted person as a customer from the first characteristic; and switching an image displayed on the image display medium in accordance with the estimated second characteristic as the customer.

Preferably, the second characteristic is at least one of gender, age, and occupation.

Preferably, priority in accordance with the second characteristic is set to the image displayed by switching.

Preferably, the image display medium is an image display medium of an image display apparatus.

Preferably, the photographed image is a photographed image of a person who uses a game machine, and wherein the image display apparatus is the one for displaying contents of a game in the game machine.

Preferably, an image displayed by the image display apparatus includes an advertisement associated with the game or a character appeared in the game.

Preferably, the photographed image is a photographed image of a person who watches television, and wherein the image display apparatus is the one for displaying a television program.

Preferably, an image displayed by the image display apparatus includes a television advertisement and an advertisement synthesized in a specified area in a screen of the program.

Preferably, the photographed image is a photographed image of a person who uses a communication network terminal, and wherein the image display apparatus is the one for displaying an image transmitted via the communication network.

Preferably, an image displayed by the image display apparatus includes an advertisement transmitted via the communication network.

Preferably, the image display medium is a hardcopy image display medium.

Preferably, the hardcopy image display medium is a seal printing or receipt.

Preferably, switching an image displayed on the hardcopy image display medium is at least one of changing a background, changing a synthesized character and changing contents of image processing to be executed on the displayed image.

In order to attain the first object described above, the second aspect of the present invention provides an image display method, comprising the steps of: inputting voice of a person; estimating a characteristic of the person based on the input voice or semantic contents of the voice; and switching an image displayed on an image display apparatus in accordance with the estimated characteristic.

Preferably, the characteristic is a characteristic of a person as a customer.

Preferably, the characteristic of the person as the customer is at least one of gender, age and occupation.

Preferably, the image display medium is an image display medium of an image display apparatus or a hardcopy image display medium.

In order to attain the first object described above, the third aspect of the present invention provides an image display method, comprising the steps of: extracting a person in a photographed image; performing person identification for the extracted person; and switching an image displayed on an image display medium in accordance with an individual subjected to the person identification.

Preferably, facial images are previously registered and the person identification is performed by referring to the facial images.

Preferably, the image is switched and displayed based on priority corresponding to each individual.

Preferably, the image display medium is an image display medium of an image display apparatus or a hardcopy image display medium.

In order to attain the second aspect described above, the fourth aspect of the present invention provides an image display method, comprising the steps of: photographing a specified area in which an image to be displayed on an image display apparatus can be recognized thereby obtaining a photographed image; extracting a person in the photographed image; detecting information with regard to at least one of a distance, a direction, a height of a face, and a moving direction of the extracted person relative to the image display apparatus; and displaying an image on the image display apparatus after modifying or changing the image based on the information such that the image can easily be recognized by the person.

Preferably, geographical conversion processing is performed to the display image in accordance with a direction or a distance and a direction of the person relative to the image display apparatus such that the image displayed on the image display apparatus can be seen similarly to the image seen from the front by the person.

Preferably, the center of the image displayed on the image display apparatus is shifted along with a movement of the person relative to the image display apparatus.

Preferably, the center of the image displayed on the image display apparatus is shifted in accordance with a height of a face of the person.

Preferably, the image displayed on the image display apparatus is enlarged or reduced, or display contents of the image are changed in accordance with a distance between the person and the image display apparatus.

Preferably, in a case of a plurality of the persons, the image displayed on the image display apparatus is displayed after divided in accordance with a position of each person.

Preferably, the display image is further corrected such that deviation of color is corrected in accordance with luminosity of lighting and tint around the image display apparatus.

### BRIEF DESCRIPTION OF THE DRAWINGS

FIG. 1 is a schematic view showing one embodiment of an image display system for executing the image display method according to the present invention.

FIG. 2 is a flowchart showing an embodiment of a method of executing the image display method according to a first mode of the present invention.

FIG. 3A is an exemplary view showing a case where a person is standing in an oblique direction relative to a display screen in a fourth mode of the present invention, and FIG. 3B is an exemplary view showing a state where an image is expanded in a horizontal direction to allow the image easy to see for the person in the oblique direction.

FIG. 4A is an exeplary view showing a state where the person approaches straight to the display screen, and FIG. 4B is an exemplary view showing a state where the person moves in a parallel direction to the display screen.

FIG. 5 is an exemplary view showing a state where a plurality of persons of different heights are standing relative to the display screen in a fourth mode of the present invention.

FIG. 6 is an exemplary view showing a state where a plurality of persons are standing at different positions relative to the display screen in a fourth mode of the present invention.

### DETAILED DESCRIPTION OF THE INVENTION

An image display method according to the present invention will be described below in detail based on the preferred embodiments shown in the accompanying drawings.

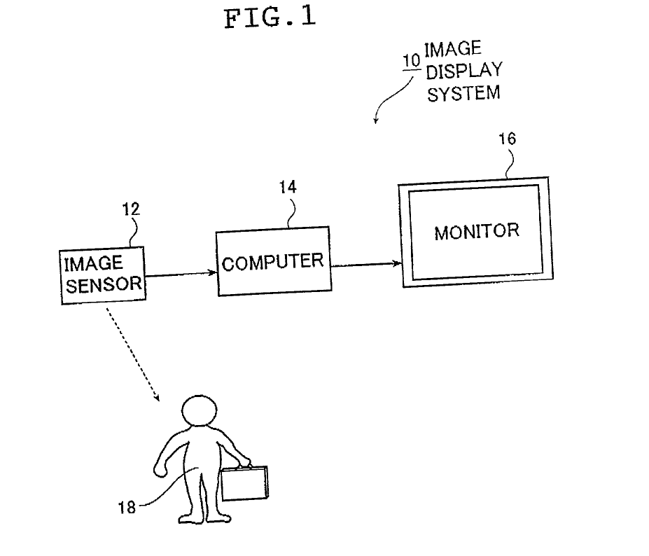

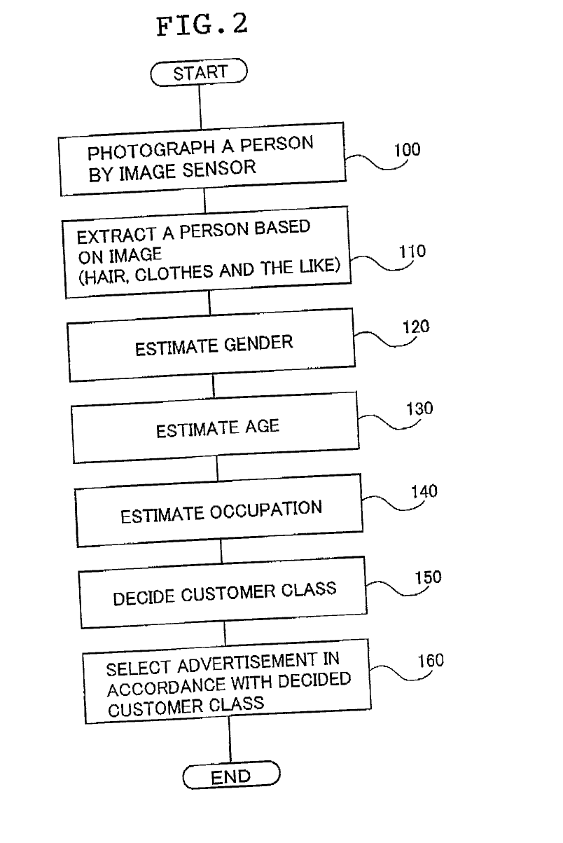

First, the image display method of first, second and third modes of the present invention will be described with reference to FIG. 1 and FIG. 2.

A first embodiment of the image display method according to the first mode of the present invention is the one where an advertisement is timely displayed so as to fit with characteristics of persons, particularly, customers (customer class for example) by switching an advertisement display in accordance with the characteristics of persons, particularly, preferably, characteristics as customers, namely, characteristics of the customers, in a store such as a shopping center.

FIG. 1 is a schematic view showing one embodiment of an image display system for executing the image display method according to the first mode of the present invention. Note that the image display system shown in FIG. 1 also can execute an image display method according to a second mode of the present invention described later.

In FIG. 1, an image display system 10 of this mode mainly comprises an image sensor 12, a computer 14 and an image display apparatus (monitor) 16. Although FIG. 1 shows only one image sensor 12 and image display apparatus 16, the image sensor 12 and the image display apparatus 16 make a pair practically and a plurality of the pairs are installed in various locations in the store, each of which is connected to the computer 14.

The image sensor 12, making a pair with the image display apparatus 16, is set near the image display apparatus 16 or incorporated directly in the image display apparatus 16, and is installed in various locations in the store with the image display apparatus 16. Then, the image sensor 12 photographs a person (customer) 10 passing in front of the image display apparatus 16 paired with the image sensor 12 to send photographed images to the computer 14. The computer 14 extracts the person from the photographed images sent from each image sensor 12 connected thereto, estimates gender, age, occupation and the like of the person, and decides a characteristic, particularly, preferably, (characteristic of a customer, that is, customer class) of the person 18 photographed in front of the image display apparatus 16. The computer 14 then selects an advertisement corresponding to the decided characteristic of the customer from database to display on the image display apparatus 16.

The image display apparatus 16 is the one for displaying an image for advertisement on an image display medium thereof and is favorably exemplified by an electronic poster, an electronic information board and the like.

The image display apparatus to be used in the present invention is not particularly limited. As long as the images for advertisement can be displayed to customers, it is not limited to such a poster or board, and is exemplified by various types of display apparatus including a CRT display apparatus, an LCD apparatus, a plasma display apparatus, an EL display apparatus, electronic paper and the like. Other examples of the image display apparatus may include various types of projectors such as a liquid crystal type, DMD type and so on, and, further, a conventional type of a projector which projects the image on a screen from a front of the screen or a back thereof, or a conventional projector which projects the image on a wall or a glass sheet.

Hereinafter, the image display method of the embodiment will be described along the flowchart shown in FIG. 2.

In this embodiment, it is assumed that advertisement images to be displayed on the image display apparatus 16 are previously registered with the database by allowing the advertisement images to correspond to the customers characteristics. When the characteristic of the customer is decided, the advertisement corresponding to the characteristic of the customer is selected and displayed on the image display apparatus 16 close to the customer.

First, in step 100, when the person (customer) 18 moving in the store passes in front of one image display apparatus 16, the image sensor 12 paired with the image display apparatus 16 photographs the person 18. The photographed images are sent from the image sensor 12 to the computer 14. At this time, the image sensor 12 may be set in an ON state every time to continue photographing and send the photographed images to the computer 14. Alternatively, the image sensor 12 may be set in an OFF state normally and is turned on to start photographing only when a person (moving object) approaches the sensor.

In the next step 110, the computer 14 extracts the person from the photographed images received, performs a series of processing in a subsequent step, and decides the characteristic of the customer.

As a method of extracting a person, there is a method disclosed in Japanese Patent Laid-Open No. Hei 8 (1997)-122944 gazette filed by the applicant of the present invention, which is the method of extracting a facial area of a person, particularly, hair. After extracting the facial area, a torso area is extracted as an area under the facial area, and an outline shape under the torso area is extracted. Thus, data is prepared for deciding the characteristic of the customer as described below.

Note that, in addition to the above-described gazette, as a method of extracting a particular area such as a person's facial area, methods disclosed in Japanese Patent Laid-Open No. Hei 4 (1992)-346333, No. Hei 5 (1993)-158164, No. Hei 5 (1993)-165120, No. Hei 6 (1994)-160993, No. Hei 8 (1996)-184925, No. Hei 9 (1997)-101579, No. Hei 9 (1997)-138470, No. Hei 9 (1997)-138471, No. Hei 9 (1997)-146194, No. Hei 9 (1997)-19757 gazettes and the like can be also preferably utilized.

Next, in step 120, the computer 14 estimates gender of the person 18 photographed.

Decision of gender of the person is executed by adding a decision point for female or male with regard to various criteria described below.

For example, as a result of the hair extraction, when volume of the hair area is large, or when the hair area is thin and the hair is considered to be long hair, or when the face size is small, the female decision point is added. In another case where the outline shape under the torso is considered to be a skirt based on a shape of a clothes extracted by a pattern matching, the female decision point is added or the person is decided to be a female immediately.

In addition, when tint (color distribution) of clothes has much hue of red, pink or the like, the female decision point is added. As other criteria for adding the female decision point, presence of makeup, presence of accessories and the like can be used. Specifically, presence of the makeup is decided based on tint of a face (skin). Moreover, it tint of a lip has more chroma than a standard color statistically obtained from a normal lip on which no lipstick is put, it is decided that the person uses a lipstick. Further, presence of use of an eye shadow is decided by detecting a color around eyes. Still further, whether or not the person wears accessories such as earrings is decided based on a shape around an ear. When these female decision results are affirmative, the female decision point is added.

On the contrary, when the person is not a female (low female decision point), and for example, when the person has a large or squarish face, when the person has a darkish area around the lip, or when the person has beard or mustache on his face, it is decided that the person is a male based on the decision criteria typical to male.

Note that, decision of female (male) is not limited only to these criteria, and it is preferable to decide whether the person is female or male by adding a factor that discriminates male and female in accordance with fashion of an era and the like.

Next, in step 130, age of the person 18 photographed is estimated.

Although a variety of methods to estimate age of a person are conceived, for example, height of the person photographed is calculated based on the photographer image, whereby estimation of an adult, a high/junior high school student, an elementary school student, an infant and the like is performed based on the height. A known art is used to calculate the height of a person in the photographed image.

Moreover, for example, based on the hair image previously extracted, when volume of the hair is small or the color of the hair is white, it is decided that the person is an aged person.

Next, in step 140, occupation of the person 18 photographed is estimated.

Decision of the occupation is mainly executed based on the clothes. Specifically, for example, when there is high possibility of suit-type clothes based on shape, density (distribution) or tint (color distribution) of the clothes, it is decided that the person is of a salaried worker. Alternatively, when the clothes is considered to be an uniform-type clothes from shape and tint of the clothes, it is decided that the person is a student including a high/junior high school student with taking the result of the foregoing gender estimation into consideration as well.

Next, in step 150, the foregoing estimation results are pieced together to decide the characteristic of the customer with regard to the person 18 photographed. The characteristic of the customer shall include at least one factor of gender, age, occupation and the like of the person. Although there may be a case where it is difficult to settle the characteristic of the customer to one characteristic, in such a case, it is considered that classification accuracy for the characteristic of the customer is quantified to set priority.

When the characteristic of the customer is decided, the advertisement corresponding to the characteristic of the customer is selected from the advertisements previously registered with the database, and is displayed on the image display apparatus 16.

For example, when it is decided that the person is a male, an adult, and a salaried worker, the advertisement for a male adult, who is a member of society, is displayed, and when it is decided that the person is female, and student, the advertisement for a female student is displayed. At this time, if the priority is set to the decision result of the characteristic of the customer as described above, the advertisement display is switched depending on the priority. A display order or a display time may be adjusted depending on the priority.

Next, a second embodiment of the present invention will be described.

The second embodiment is substantially similar to the above-described first embodiment, which switches the advertisement display in accordance with the characteristic of the customer in a store. The second embodiment is not the one that simply changes the advertisement display in accordance with the characteristic of the customer passing in front of the image display apparatus, but the one that displays the advertisement with taking a sales strategy and the like of a store into consideration as well.

Specifically, as a result of collecting statistical data of the characteristic of the customer, who passes in front of the image display apparatus, as in the first embodiment, a statistical tendency may be recognized in the characteristic of the customer with regard to a season, a date, a time band or a particular anniversary. In such a case, with aiming at a sale that puts an emphasis on the characteristic of a certain customer in accordance with the tendency, a parameter setting of algorithm for a person recognition in deciding the characteristic of the customer is changed such that a decision result showing the characteristic of such a customer is apt to come out.

For example, if there is a tendency that young female customers increases before February 14 (St. Valentine's day), the parameter setting is changed during the season so as to increase accuracy for deciding that the customers are young female customers, thus the advertisements for young female customers are increased.

Alternatively, the date and the time band are converted into numerical values based on the foregoing statistical results, which may be taken into consideration to an accuracy calculation for classifying the characteristic of the customer.

Next, description will be made for a third embodiment of the present invention.

The third embodiment is the one in which the store clerk checks an automatic decision result for the decision of the characteristic of the customer in the foregoing first and second embodiments through a monitor, and the store clerk corrects the result if there is an error in the decision of the characteristic of the customer.

A certain amount of data correction results are aggregated, and the parameter setting of algorithm for an automatic customer characteristic decision is adjusted with regard to a classification of the characteristic of the customer with many decision errors.

For example, if many decision errors are made for the shape of clothes, the parameter setting is adjusted so as to decrease points for the clothes decision. Alternatively, an estimated point value to be given to the classification of the characteristic of the customer with many decision errors is finely adjusted to the point lower than a current value so as not to decide the classification of the characteristic of the customer incorrectly.

Next, description will be made for a fourth embodiment of the present invention.

The fourth embodiment is the one, for example, that switches display contents in a commercial area that appears in a game screen of a game machine at an amusement arcade in accordance with the characteristic of the customer, who is playing the game.

In this embodiment, in the amusement arcade or the like for example, the image sensor is attached to each game machine to photograph the person who is currently using the game machine and a computer of the game machine decides the characteristic of the customer of the person, who is playing the game, based on the photographed image similarly to the above-described first embodiment. Then, the computer selects the advertisement suitable for the decided characteristic of the customer from the advertisements previously registered with the database or the like and the advertisement is displayed on a specified area on the game screen.

In this case, the advertisement contents are made to be accessory data independent of the game software, and decision information of the characteristic of the customer, which is decided by the computer of the game machine, is input as an external signal corresponding to a game program, thus the corresponding advertisement is set on the specified area in the screen. In this case, a character in the game may be switched in accordance with the characteristic of the customer.

Next, description will be made for an embodiment of a third mode of the present invention (hereinafter referred to as a fifth embodiment of the present invention.

The embodiment is the one that, in the case where the image sensor is attached to a home television and the television includes a computer installed with a person identification (or decision of the characteristic of the customer) software, the display of the commercial and the like can be switched in accordance with the person watching the television.

When the person identification software is used in this embodiment, facial images of family members shall be previously registered with a recording device in the television. Alternatively, a broadcasting station needs to set identification information indicating the classification of the contents to each commercial before broadcasting. At each home, a parent shall previously set a kind of commercial that he/she does not want his/her child to watch.

In the case where the foregoing conditions are previously set, it is assumed that a child is watching a television while sitting in front of it. The image sensor installed in the television photographs the child, and the computer of the television extracts a face of the child from the photographed image to perform matching with the previously registered facial images of the family members. As a result, in the case where it is decided that the child is watching the television, when the computer of the television detects the identification information of the commercial, which is set as the one that the parent does not want his/her child to watch while broadcasting, the display of such a commercial is prohibited. Instead, another commercial previously registered or another program is displayed.

At this time, priority may be set with regard to who is prioritized among the family members, or the priority may be provided to the contents to be displayed for each family member.

In the case where a decision software for the characteristic of the customer is used, the computer in the television decides the characteristic of the customer based on the photographed image photographed by the image sensor. And, when the classification indicating the contents of the commercial is not suitable for the characteristic of the customer, the television temporarily stores the commercial independently of the program. Then, during the commercial time, the television displays the previously registered commercial in a particular category corresponding to the characteristic of the customer. Note that the abovedescribed person identification software and the decision algorithm for the characteristic of the customer are not only activated separately, but the contents of the decision algorithm for the characteristic of the customer may be incorporated in the person identification software.

Moreover, in this embodiment, not only the commercial itself is switched as described above, the advertisement in accordance with the characteristic of the customer may be displayed on a specific region in a program screen. For example, in a baseball broadcast, the advertisement may be synthesized and displayed as if it is actually on a fence or base grounds, and the advertisement may be synthesized and fit into a part of setup in a drama screen for display.

Next, a sixth embodiment of the present invention will be described.

The embodiment is the one where, in the Internet and a personal computer communications, the contents of the commercial is switched in accordance with the characteristic of the customer.

The embodiment relates to a personal computer having the image sensor, having the decision software for the characteristic of the customer installed therein, and connected to a server via a communication network such as the Internet. The image sensor connected to the personal computer photographs the person who uses the personal computer, and the personal computer decides the characteristic of the customer based on the photographed image to automatically transmit information of the characteristic of the customer as input information to the server.

A party (a server of a site in the Internet or a server of a communication destination) that has received the information of the characteristic of the customer returns the commercial according to the characteristic of the customer to display the commercial on the personal computer.

Note that the person identification software may be used instead of the decision software for the characteristic of the customer. Moreover, both of the softwares may be installed in the personal computer.

Next, an embodiment of a second mode of the present invention (hereinafter referred to as a seventh embodiment of the present invention) will be described.

The embodiment is not the one that decides the characteristic of the customer by using the image data as in each of the foregoing embodiments, but is the one that decides the characteristic of the customer by using voice recognition. Specifically, voice of a person such as conversation is input to the computer by a voice-input device, and the computer estimates gender of the person and whether the person is an adult or a child based on tone of the voice input. In addition, gender of the person, whether the person is adult or child, occupation and the like are further estimated based on the conversation contents, thus the characteristic of the customer is estimated. The image display such as the advertisement is switched in accordance with the estimated characteristic of the customer.

In this embodiment, not only estimation of the characteristic of the customer by voice, but also estimation of the characteristic of the customer by image recognition as in the first embodiment may be combined in order to improve estimation accuracy of the characteristic of the customer. Combination of the image and the voice enables the computer to perform estimation of the characteristic of the customer in a considerably high accuracy.

Many modifications can be considered for the each of the above-described embodiments.

For example, in the case where a plurality of persons are present in the image photographed by the image sensor and a plurality of characteristics of the customers are detected. Then, priority is set in the characteristic of the customer and the advertisement corresponding to the characteristic of the customer with the highest priority among the decided characteristics of the customers may be displayed.

In addition, individual images of customers are stored in the database and a face is extracted from the photographed image by the image sensor when the customer visits the store. Thereafter, the person identification software is activated for the face images previously registered with the database to perform person identification, and the commercial for a frequent customer may be displayed when it is decided that the customer is the frequent customer of the store by using a store-visiting frequency count value.

Further, not only the display image of an electric device is switched in accordance with result of the decision of the characteristic of the customer, but also the display contents may be switched by means of a mechanical structure, for example, such that display shelves of articles are rotated and moved or arrangement in the store is changed.

For example, in the case of a photographing output apparatus of a seal printing such as Prikura (Print club, a registered trademark) or the like, the image sensor and the computer for deciding the characteristic of the customer are attached to a machine (including such photographing output apparatus), and the characteristic of the customer of the person who uses the machine is decided. Furthermore, a background and a synthesized character may be changed and various image processing contents such as soft-focus, contrast and tint change may be changed according to statistical taste of the characteristic of the customer.

In addition, a classification result of the characteristic of the customer is stored and aggregated to grasp the statistical tendency of the taste of the characteristic of the customer, which may be reflected on the image display.

In the above-described example, contents of an indoor/outdoor advertisement or the like to be displayed on the image display medium of the image display apparatus have been switched so as to fit with the decided characteristic of the person, particularly, that of the person as a customer; however, the present invention is not limited to this type and may be reflected on a hardcopy making use of a hardcopy image display medium as the image display medium.

For example, it goes without saying that the image display method of the present invention may not only be reflected on the display on the image display medium of the image display apparatus such as the photographing output apparatus and the like of the above-described seal printing, but also be directly reflected on the seal printing itself to be output. Namely, it is permissible that a background or a character to be composited of the seal printing to be output may be changed or various types of image processing contents such as soft-focus, contrast, tint change and the like may be changed.

Further, in stores, contents of printing on a front or back side of a receipt to be handed over to customer at a checkout counter may be switched.

As described above in detail, according to the embodiments, the characteristic of the customer is automatically decided and the image display contents such as the advertisement are switched and displayed in accordance with the characteristic of the customer. Therefore, the advertisement display or image display that is not laborious, and is timely and appropriate can be performed. The effects of the advertisement or the effects or values of the display image to the customer can be enhanced to the optimum.

The image processing method according to the first, second and third modes of the present invention are basically constituted as described above.

Next, the image processing method according to the fourth mode of the present invention will be described with reference to FIG. 1 and FIGS. 3 to 6.

The image processing method according to the fourth mode of the present invention can also be executed by the image display system 10 shown in FIG. 1 similarly to the image processing method according to the first mode of the present invention.

In FIG. 1, the image sensor 12 is the one for photographing the person 18 in front of the image display apparatus 16 or photographing the person 18 passing in front of the apparatus 16. The image sensor 12 is provided near the image display apparatus 16 or is directly incorporated in the image display apparatus 16. Although the image sensor 12 is not particularly limited, mounting a fisheye lens, for example, enables the sensor 12 to photograph a wide range with one lens, which is effective. The person at the center of the photographed image is an object to whom the image is displayed.

The computer 14 is the one that receives the image photographed by the image sensor 12, extracts the person from the photographed image, and detects information such as position relative to the image display apparatus 16 and the like of the extracted person. Then, the computer 14 controls the display method of the Image to be displayed on the image display apparatus 16 based on the information detected.

As a method of extracting the person, the method exemplified in the image display methods of the first, second and third modes of the present invention can be used.

The image display apparatus 16 is the one, for example, for displaying the image such as the advertisement to the person 18 and the like passing in front of the apparatus 16. As the image display apparatus 16, the ones exemplified in the image display methods of the first, second and third modes of the present invention can be used. The image to be displayed is not particularly limited and may be a still image or a moving image. Moreover, voice may be output from an attached speaker.

Hereinafter, an operation of one embodiment of the fourth mode of the present invention will be described.

The embodiment is the one where a display mode of the display image is automatically modified so as to display an image easy to see for the person or the display contents of the display image is automatically changed.

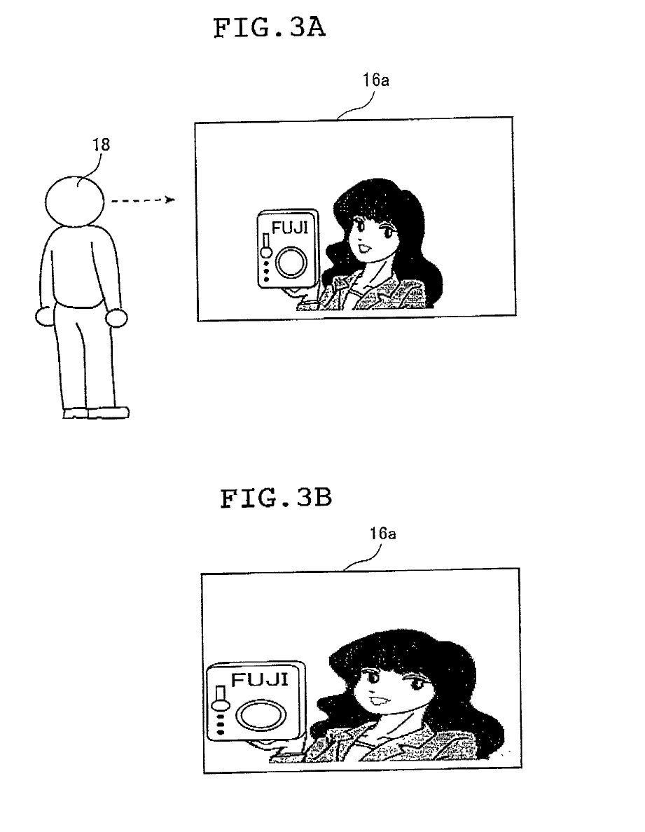

First, as shown in FIG. 3A, when the person 18 is in the oblique direction relative to a display screen 16a of the image display apparatus 16, the display image is made to be a picture expanded in the horizontal direction as shown in FIG. 3B, so that the display image can be seen in an appropriate shape by the person 18 in the oblique direction.

At this time, when the computer 14 receives the image of the person 18 photographed by the sensor 12, the computer 14 extracts the person 18 from the image, and detects which position the person 18 is relative to the image display apparatus 16 based on the position, the size and the like in the image.

Then, the display image is expanded in the horizontal direction as shown in FIG. 3B corresponding to a distance, a direction and the like from the image display apparatus 16 to modify the image into the shape easy to see for the person 18.

In this case, a ratio of expanding the image in the horizontal direction is previously decided in accordance with the distance and the direction, and the ratio may be simply applied to the image for expansion. Alternatively, images expanded in various ratios are previously prepared, and the image may be immediately switched to the one of a certain ratio. Peripheral portions of an original image may be cut off and wasted due to the expansion in the horizontal direction, but it will not be a problem since a primary portion of the display image is normally at the central portion.

Note that it is necessary to display a modified image where the original display image is projectively converted in accordance with the position of the person in order to show a precisely accurate image. (As widely known materials of a projection conversion, “An image analysis handbook” published from Tokyo University Publishing House, pp582 to 585 and the like are known.) However, in a usage of the advertisement display, it is considered that a simple expansion method of the image in the horizontal direction can sufficiently improve a visual effect.

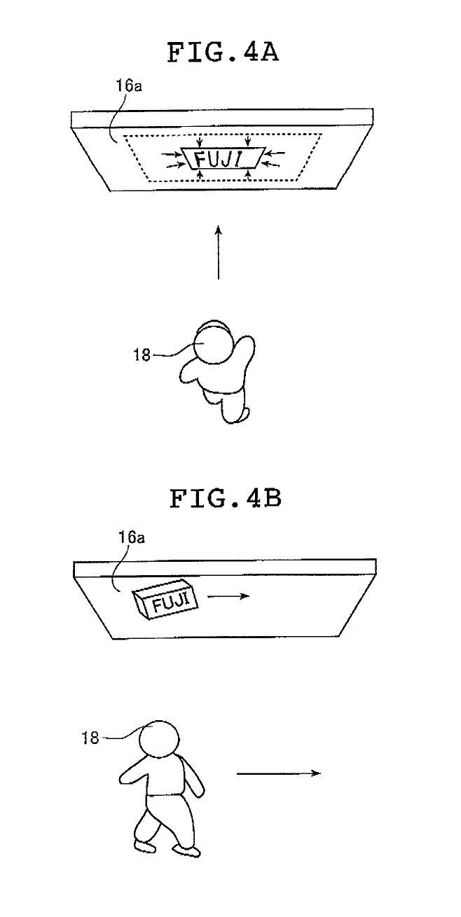

Next, as shown in FIGS. 4A and 4B, in the case where the person moves in front of the display screen 16a of the image display apparatus 16, the display image is made to shift along with a movement of the person 18.

For example, in the case where the person 18 walks toward the display screen 16a as shown in FIG. 4A, when the computer 14 that received the photographed image of the image sensor 12 judges that the person 18 approaches the display screen 16a, the image is displayed in a magnified state when the person 18 is at the position far from the display screen 16a. The display image is displayed by gradually reducing its size as the person 18 approaches the display screen 16a such that the display image is adjusted to a proper size for the person 18 to see easily. Alternatively, the image display contents are edited in a hierarchical structure. When the person 18 is far from the screen, a large-sized rough image with details omitted is displayed, and when the person 18 approaches to a certain distance, the displayed image may be changed to an image with the details displayed therein.

Moreover, as shown in FIG. 4B, in the case where the person 18 moves, for example, in front of the display screen 16a to right/left, the display image is also moved according to the movement of the person 18 so as to follow the person 18.

As in the above examples, in the case where the image display apparatus 16 is provided near the entrance/exit of the store and the person 18 moves in front of the image display apparatus 16, it is further effective that the computer judges according to the moving direction of the person 18 whether the person is an visiting customer or a leaving customer and the contents of the display image is accordingly changed.

Next, since the height of faces varies depending on the heights of the persons in front of the image display apparatus, a display position of the image needs to be adjusted in accordance with the height of the faces.

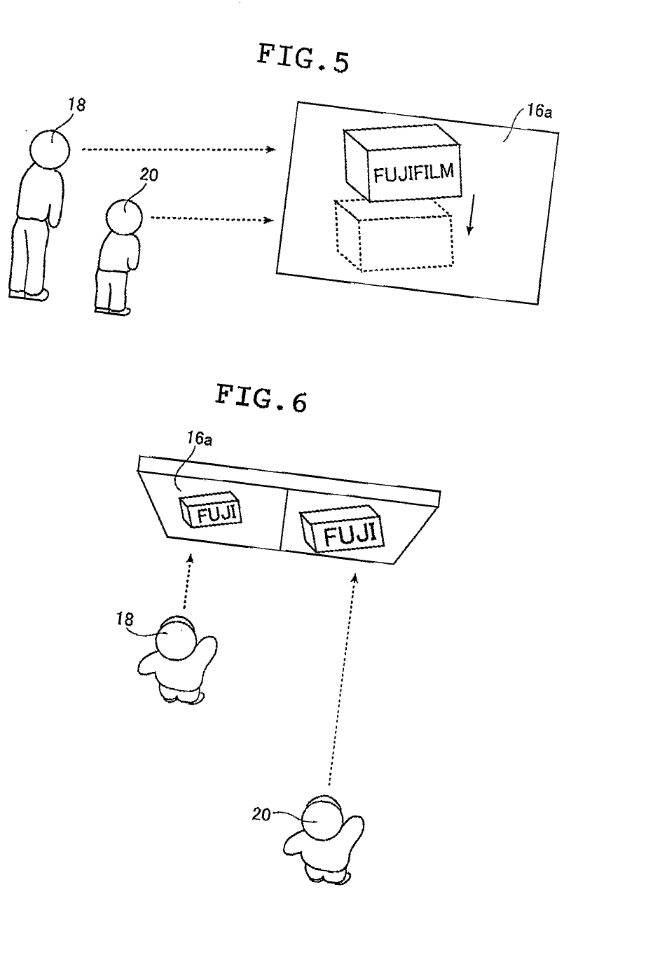

For example, as shown in FIG. 5, when a tall person 18 is in front of the display screen 16a of the image display apparatus, the center of the image displayed on the display screen 16a is set at a high position in accordance with the height of the face.

In addition, when a short person 20 is in front of the display screen 16a, the center of the image displayed on the display screen 16a is shifted to a low position in accordance with the height of the face.

Next, as shown in FIG. 6, in the case where a plurality of persons 18 and 20 are in the positions having distances of large differences from the display screen 16a, the display screen 16a is divided in plural numbers, and the image display suitable for each person 18 and 20 is performed on each of the divided screens.

For example, as shown in FIG. 6, for the person 20 far from the display screen 16a, the image is displayed in an enlarged state within a divided screen on the side of the person 20. Alternatively, only important items are displayed in a large size.

In addition, for the person 18 close to the display screen 16a, the display image including the detail information is displayed within a divided screen on the side of the person 18.

Thus, as shown in the case of FIG. 4A described above, it is further effective that the image edited in the hierarchical structure corresponding to the distance is changed and displayed in accordance with the detected distance of the person to the screen.

In actual circumstances, there is a case where a great number of people pass in front of the screen one after another such as a rush hour in a train station. In such a case, although it is difficult to cope with all the persons, effects of a certain extent can be obtained by performing the image display focusing on a particular person among them.

Each of the above examples is not limited to the case where it is executed individually. Specifically, in some cases, a few of such circumstances are realized in a combined state. In such cases, each of the image display methods in accordance with the circumstances can be combined and executed, thereby more enhanced display effects are obtained.

For example, even in the case where the person moves in front of the display screen to right/left, various cases are conceived, for example, the height of the person is tall or short. And, the person not only approaches the display screen directly from the front, but also approaches from the oblique direction. When the person approaches from the oblique direction, the combination of the image display for the movement that approaches from the front and the image display for the movement to right/left are employed. In any case, the image display is made such that the person can see the display in the best state depending on a positional relation and the like between the person and the image display apparatus at every moment.

Moreover, with regard to all of the above examples, if lighting around the image display apparatus is dim or tinted, color of the image is changed from the one originally intended to show. Therefore, it is further effective that the image is corrected such that deviation of color is corrected according to luminosity of lighting and tint around the apparatus.

Not only information such as the position of the person relative to the display screen is detected based on the photographed image by the image sensor, but also information of the so-called customer class such as gender and age of the person is detected. Thus, display contents maybe changed to the one according to the customer class.

According to the embodiment of the present mode described above, the position and the movement of the person are automatically detected regardless of the position of the person relative to the image display apparatus and regardless of the movement of the person, and the image display is modified or changed such that the person can see the image in the optimum state. Accordingly, the person can enjoy the image from any position, and a supplier of the image can enhance the effect of the advertisement maximumly.

The image display method of the fourth mode of the presents invention is basically constituted as above.

Hereinbefore, although the image display method of the present invention has been described in detail illustrating various embodiments, the present invention is not limited to the foregoing examples. It is a matter of course that various modifications and changes can be made therein without departing from scope of the present invention.

As described above in detail, according to the first, second and third modes of the present invention, the advertisement display or indoor/outdoor image display can be executed by automatically switching to the advertisement or image suitable for the characteristic of the person, particularly, that as the customer, which can enhance the effect of the advertisement or the effect or value of the display image to the person or customer.

Moreover, as described above in detail, according to the fourth mode of the present invention, the image display easily seen by the person can be automatically realized regardless of the position of the person in front of the image display apparatus and regardless of the movement of the person.

What is claimed is:

1. An image display method, comprising the steps of:
extracting a person in a photographed image;
detecting a first characteristic of said extracted person; and
switching an image displayed on an image display medium in accordance with the first characteristic of said extracted person.

2. The image display method according to claim 1,
wherein said first characteristic is at least one of a height, a size of a face, a shape of hairs, a shape of clothes, density distribution of clothes, color distribution of clothes, presence or absence of makeup, and presence or absence of accessories.

3. The image display method according to claim 1, further comprising the steps of:
estimating a second characteristic of said extracted person as a customer from said first characteristic; and
switching an image displayed on said image display medium in accordance with said estimated second characteristic as the customer.

4. The image display method according to claim 3,
wherein said second characteristic is at least one of gender, age, and occupation.

5. The image display method according to claim 3,
wherein priority in accordance with said second characteristic is set to said image displayed by switching.

6. The image display method according to claim 1,
wherein said image display medium is an image display medium of an image display apparatus.

7. The image display method according to claim 6,
wherein said photographed image is a photographed image of a person who uses a game machine, and wherein said image display apparatus is the one for displaying contents of a game in said game machine.

8. The image display method according to claim 7,
wherein an image displayed by said image display apparatus includes an advertisement associated with said game or a character appeared in said game.

9. The image display method according to claim 6,
wherein said photographed image is a photographed image of a person who watches television, and wherein said image display apparatus is the one for displaying a television program.

10. The image display method according to claim 9,
wherein an image displayed by said image display apparatus includes a television advertisement and an advertisement synthesized in a specified area in a screen of said program.

11. The image display method according to claim 6,
wherein said photographed image is a photographed image of a person who uses a communication network terminal, and wherein said image display apparatus is the one for displaying an image transmitted via said communication network.

12. The image display method according to claim 11,
wherein an image displayed by said image display apparatus includes an advertisement transmitted via said communication network.

13. The image display method according to claim 1,
wherein said image display medium is a hardcopy image display medium.

14. The image display method according to claim 13,
wherein said hardcopy image display medium is a seal printing or receipt.

15. The image display method according to claim 13,
wherein switching an image displayed on said hardcopy image display medium is at least one of changing a background, changing a synthesized character and changing contents of image processing to be executed on the displayed image.

16. An image display method, comprising the steps of:
inputting voice of a person;
estimating a characteristic of said the person based on said input voice or semantic contents of the voice; and
switching an image displayed on an image display apparatus in accordance with said estimated characteristic.

17. The image display method according to claim 16,
wherein said characteristic is a characteristic of a person as a customer.

18. The image display method according to claim 17,
wherein said characteristic of the person as the customer is at least one of gender, age and occupation.

19. The image display method according to claim 16,
wherein said image display medium is an image display medium of an image display apparatus or a hardcopy image display medium.

20. An image display method, comprising the steps of:
extracting a person in a photographed image;
performing person identification for said extracted person; and
switching an image displayed on an image display medium in accordance with an individual subjected to said person identification.

21. The image display method according to claim 20,
wherein facial images are previously registered and said person identification is performed by referring to said facial images.

22. The image display method according to claim 20,
wherein said image is switched and displayed based on priority corresponding to each individual.

23. The image display method according to claim 20,
wherein said image display medium is an image display medium of an image display apparatus or a hardcopy image display medium.

24. An image display method, comprising the steps of:
photographing a specified area in which an image to be displayed on an image display apparatus can be recognized thereby obtaining a photographed image;
extracting a person in said photographed image;
detecting information with regard to at least one of a distance, a direction, a height of a face, and a moving direction of said extracted person relative to said image display apparatus; and
displaying an image on said image display apparatus after modifying or changing said image based on said information such that the image can easily be recognized by said person.

25. The image display method according to claim 24,
wherein geographical conversion processing is performed to said display image in accordance with a direction or a distance and a direction of said person relative to said image display apparatus such that the image displayed on said image display apparatus can be seen similarly to the image seen from the front by said person.

26. The image display method according to claim 24,
wherein the center of the image displayed on said image display apparatus is shifted along with a movement of said person relative to said image display apparatus.

27. The image display method according to claim 24,
wherein the center of the image displayed on said image display apparatus is shifted in accordance with a height of a face of said person.

28. The image display method according to claim 24,
wherein the image displayed on said image display apparatus is enlarged or reduced, or display contents of the image are changed in accordance with a distance between said person and said image display apparatus.

29. The image display method according to claim 24,
wherein, in a case of a plurality of said persons, the image displayed on said image display apparatus is displayed after divided in accordance with a position of each person.

30. The image display method according to claim 24,
wherein the display image is further corrected such that deviation of color is corrected in accordance with luminosity of lighting and tint around said image display apparatus.
